(19) United States
(12) Patent Application Publication
(10) Pub. No.: US 2012/0268550 A1
(43) Pub. Date: Oct. 25, 2012

(54) INTEGRATED CONTROL SYSTEM FOR FACILITIES USING A LOCAL AREA DATA COLLECTING AND RECORDING DEVICE

(75) Inventor: Hong-Dae Park, Changwon-si (KR)

(73) Assignee: POWERTECH CO., LTD, Changwon-si (KR)

(21) Appl. No.: 13/518,510

(22) PCT Filed: Jan. 12, 2011
(86) PCT No.: PCT/KR2011/000223

§ 371 Date: Jun. 22, 2012

(30) Foreign Application Priority Data
Jan. 12, 2010 (KR) 10-2010-0002903

(51) Int. Cl. H04N 7/14

(52) U.S. Cl. 348/14.02; 348/E07.077

(57) ABSTRACT

The present invention relates to an integrated control system for facilities using a local area data collecting and recording device. The present invention comprises: a CCTV/Web-Camera for taking moving images; a still camera for taking pictures; a data collection (DAQ) unit for collecting abnormal sounds; a hard disk for converting and synthesizing data signals into digital signals, and then storing the digital signals in a compressed file; a local data collecting and recording device; a wired and wireless communication network; a communication converter for conversion to a standard protocol; a distance central/local monitoring center server for performing monitoring; first and second monitors for observation; an analysis system for the precise analysis of an accident site; and an information provider for providing information to a local on-site worker, a manager and a department or agency concerned.

### TECHNICAL FIELD

The present invention relates to an integrated control system for water management facilities such as water and sewage treatment plants and multipurpose dams, and more particularly, to an integrated control system for facilities using a local area data collecting and recording device, which can perform real-time monitoring and information interchange between a distant central/local monitoring center and a water management facility having the local area data collecting and recording device, thereby stably integrally maintaining and controlling various equipments and devices.

### BACKGROUND ART

Recently, the UN report says that almost half of the world's population will face water shortages. Water flows through all things such as air, land, human body and even world economy. Actually, whenever all kinds of products and services are sold or purchased, the corresponding water is being exchanged. It takes about 2,650 liters of water to manufacture a T-shirt, about 7,571 liters of water to produce 3.79 liters of milk, and also about 147,632 liters of water to manufacture a car. To prepare for the future water shortages, IBM itself collects and analyzes vast amounts of data generated in a complicated water supply system using advanced sensor networks, state-of-the-art computing technologies and systematic analytics, and prepares comprehensive water managing solutions, thereby saving three million dollars a year at the semiconductor manufacturing factory in North America.

The IBM's water management system shows that it is possible to somewhat restore water to its original condition using advanced IT technologies once it is contaminated by human beings. In this system, precise sensors are installed and networked in rivers or oceans, and the flow of water is measured and analyzed using a smart meter. The computing technology and the analytics are then applied on the basis of such information, thereby being capable of carrying out the smart water management. This system includes the steps of networking distributed sensors, collecting and processing sensor data and fusing information. Herein, in the networking of the distributed sensors, the sensors having built-in computer chips detect physical, chemical and biological changes in the river, while being floated or fixed in the river, and collect and transfer data in real time. Further, the continuous physical, chemical and biological data transferred from the sensors for collecting and processing the sensor data is received and inspected in real time and then classified according to specified priorities. And in the fusing of the information, a virtual river is formed online using the integrated data and then analyzed by a scientist, a policy maker, an educator and the like, and the results are used in an in-depth understanding of the ecosystem, an observation on deposits and chemical contaminants and a detailed analysis of the influence of mankind on water quality and movement of species.

In other words, an age of convergence technology between the same or different industries is coming based on the IT technology. The many remote water management systems which have been proposed in and outside the country are good precedents. However, these may be a simple technology which can operate a sensor driving controller for various equipments through remote monitoring according to previously preset programs and thus can correct errors, or a PLC (Power Line Communication) technology which is not commercialized yet. Therefore, the present invention is to propose a new integrated control system which can integrally control various equipments and devices in the water management facilities through bidirectional communication between a local on-site worker and a central/local monitoring center.

### DISCLOSURE

### Technical Problem

An object of the present invention is to provide an integrated control system for facilities using a local area data collecting and recording device, which performs a real-time monitoring through the local area data collecting and recording device disposed in the water management facilities, builds a database for information analyzed by the bidirectional communication with the local on-site worker and provides the information to the related departments, thereby integrally controlling the various equipments and devices of the water management facilities in the whole country, identifying the cause of an accident when the accident occurs, rapidly taking follow-up measures, preventing a recurrence of the accident by identifying the cause thereof and clarifying where the responsibility lies.

### Technical Solution

To achieve the object of the present invention, the present invention provides an integrated control system for facilities using a local area data collecting and recording device, comprising a CCTV/Web-Camera which has pan-tilt, zooming and high speed rotating functions with respect to various equipments and devices of the water management facilities, and takes moving images when detecting any movements after comparing a reference image with a current image, or detecting any abnormal sounds through a sensor; a still camera which is interlocked with the CCTV/Web-Camera and which follows an intruder or an accident site when the intruder or accident occurs and takes pictures at various angles; a PC-based data collection (DAQ) unit which collects various abnormal sounds detected from the sensors attached to the various equipments and devices; a hard disk which converts and synthesizes the moving images, the pictures and sound data signals into digital signals, and then stores the digital signals in a compressed file; a transceiver which receives and stores a caption data, and a speaker which gives warning to the intruder and informs a dangerous situation and a repairing method; one or more local data collecting and recording devices which has a control part for controlling the above-mentioned elements and collecting video/audio data while being interlocked with a central/local monitoring center server; a wired and wireless communication network which performs bidirectional communication between the one or more local data collecting and recording devices and a communication converter before a central/lock monitoring center; the communication converter which converts the moving images, pictures and sound data information of the local data collecting and recording devices, which has a different transport protocol transferred from the wired and wireless communication network, into a standard protocol so as to integrally monitor the data information; a central/local monitoring center server which is interlocked with the wired and wireless communication network and the communication converter and which has a CMS (Central Management System) function of converting digital signals input to the communication converter into analog signals and providing various and convenient user support monitoring; a monitor for observation having a first monitor for observation, which splits real-time moving images and pictures transferred from the server into 1 to 64 screens, and a second monitor for observation, in which an icon is automatically displayed on an E-map when the intruder or the accident occurs in the water management facilities; an analysis system which analyzes a status of the local area water management facilities through the monitor for observation, and in which the pictures displayed on the first monitor for observation is mapped with an actual image prepared before the accident and an observing point of the 3D drawings so that the accident site can be analyzed precisely; and an information provider which builds a database of the data analyzed from the analysis system, transfers the data to a situation room of the central/local monitoring center so that the data is used in making a policy for water management in the whole country, and then also provides the data to a local on-site worker, a manager and a department or agency concerned.

Preferably, the transceiver comprises an LCD monitor which performs the bidirectional communication, receives and stores the moving images and pictures recorded and analyzed from the central/local monitoring center, the 3D drawings, and the caption data for how to deal with the accident, and splits the data into four screens.

Preferably, the second monitor for observation comprises a three-screen splitting function which displays the pictures for the accident site and the text caption analyzed with the 3D drawings at the same time, when an operator clicks the icon.

Preferably, the text caption comprises a page unit displaying function which can display date and time when the accident occurs, an accident site, a network of emergency contacts, information for how dealing with the accident all together.

### Advantageous Effects

As described above, the present invention can perform the real-time monitoring through the local area data collecting and recording device disposed in the water management facilities, can provide the data analyzed through the distance central/local monitoring center to the local on-site worker using the bidirectional communication and also can build the database for the analyzed data, and thus it has some effects as follows:
(1) it is possible to monitor the intruders and the accident occurrence in real time at the central/local monitoring center, thereby securing stability and security in controlling the local management facilities.
(2) it is possible to identify the cause of the accident and rapidly take the follow-up measures at the same time, thereby previously preventing a full-scale accident.
(3) it is possible to build a database for the analyzed data, thereby using the data in making a plan for the water management in the whole country, preventing the recurrence of the accident by identifying the cause thereof, clarifying where the responsibility lies and also exchanging various information such as know-how for water management.

### DESCRIPTION OF DRAWINGS

The above and other objects, features and advantages of the present invention will become apparent from the following description of preferred embodiments given in conjunction with the accompanying drawings, in which:

FIG. 1 is a view showing a status of integrally monitoring a water management facility, such as water and sewage treatment plants and multipurpose dams, through an integrated control system for facilities using a local area data collecting and recording device according to the present invention.

FIG. 2 is a view showing a status of precisely taking images of various equipments and devices in the water management facility, such as water and sewage treatment plants and multipurpose dams, through the integrated control system for facilities using the local area data collecting and recording device according to the present invention.

FIG. 3 is a schematic block diagram showing an unmanned A/V recording device and a wired and wireless communication network in the integrated control system for facilities using the local area data collecting and recording device according to the present invention.

FIG. 4 is a schematic block diagram showing a status of performing a monitoring and analyzing process and providing information through bidirectional communication in the integrated control system for facilities using the local area data collecting and recording device according to the present invention.

FIG. 5 is a life-size photograph showing a water management situation at a local monitoring center (in Gyeongsangnam-do), which is monitored in a central monitoring center.

FIG. 6 is a view of an E-map showing a local monitoring center (or a water and wastewater agency) in the integrated control system for facilities using the local area data collecting and recording device according to the present invention.

FIG. 7 is a view showing a status of performing a repairing (maintaining) process through a transceiver of the integrated control system for facilities using the local area data collecting and recording device according to the present invention.

### DETAILED DESCRIPTION OF MAIN ELEMENTS

| | |
|---|---|
| 10: water management facility | 20: intruder |
| 100, 110, 120: first, second and | |
| n-th local data collecting and | |
| recording devices | |
| 101: sensor | 102: CCTV/Web-Camera |
| 103: still camera | 104: camera driving part |
| 105: A/D converter | 106: storing means |
| 106a: hard disk | 106b: DAQ Unit-1 |
| 107: synthesizer | 108: transceiver |
| 108-1: speaker | 200: wired and wireless |
| | communication network |
| 300: communication converter | 400: central/local monitoring center |
| | server |
| 500: monitor for observation | |
| 510, 520: first and second monitors | |
| for observation | |
| 530: icon | 600: analysis system |
| 700: database | 610: mapping of picture and 3D |
| | drawing |
| 800: situation room | 900: information provider |
| 910: manager | 920: concerned department or agency |

### Best Mode

Hereinafter, the embodiments of the present invention will be described in detail with reference to accompanying drawings. The same reference numerals are given to the same or corresponding parts, and the description thereof will not be repeated.

An integrated control system for facilities using a local area data collecting and recording device according to an embodiment of the present invention is characterized by including a local data collecting and recording device 100, a wired and wireless communication network 200, a communication converter 300, a central/local monitoring center server 400, a monitor 500 for observation, an analysis system 600 and an information provider 900, wherein one or more local area data collecting and recording devices is provided at a water management facility such as a reservoir, a freshwater lake, a water and sewage treatment plant, a watercourse weir, a debris barrier and a multipurpose dam, thereby integrally controlling various equipments and devices in local area water management facilities scattered around the whole country.

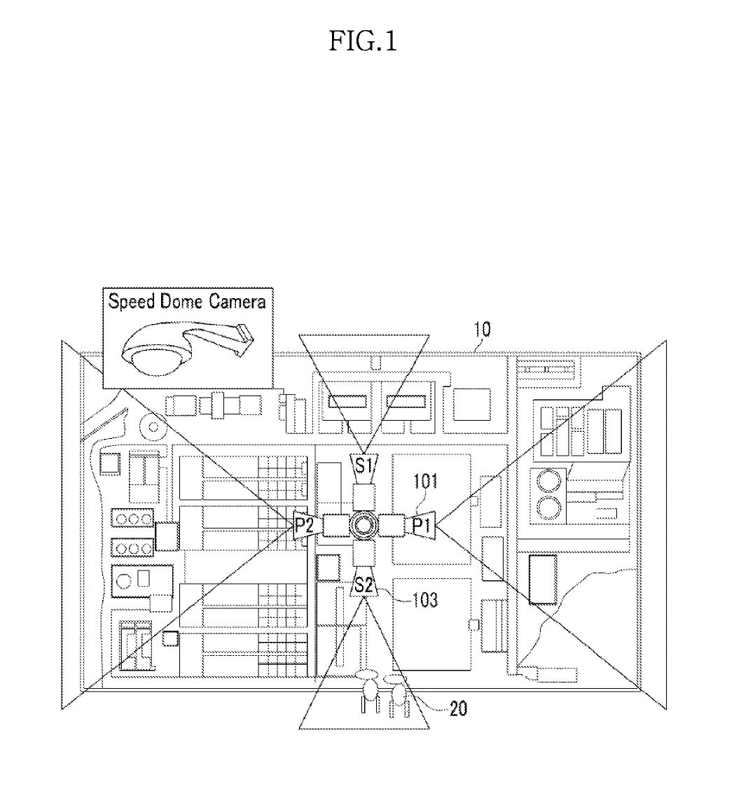

Referring to FIG. 1, the local data collecting and recording device 100 provided at the water management facility 10 in plural is a PC-based DAQ (Data Acquisition) system and an A/V (Audio/Video) recording device which are operated unmannedly by a remote command provided from a situation room of a central/local monitoring center or a previously preset program. The local data collecting and recording device 100 includes a sensor 101, a camera 102 for observation, a still camera 103, a camera driving part 104, an A/D converter 105, a DAQ unit 106a, a hard disk 106b, a synthesizer 107, a transceiver 108, a speaker 108-1 and a control part 109.

The sensor 101 is installed at various equipments (e.g., power generating equipment, electric equipment, etc.) and devices (e.g., a generator, a motor, a hydraulic oil pump, etc.) in order to detect abnormal sound or abnormal vibrating sound therearound.

If there is a difference between reference images of the various equipments and devices in the water management facility and current images thereof, or a malfunction detection signal is generated from the sensor 101, the camera 102 for observation takes moving images thereof. Herein, the reference images are still images taken in a state that there are no any movements of operators as well as any operations of the equipments, and the current images are defined as a contrary concept of the reference images.

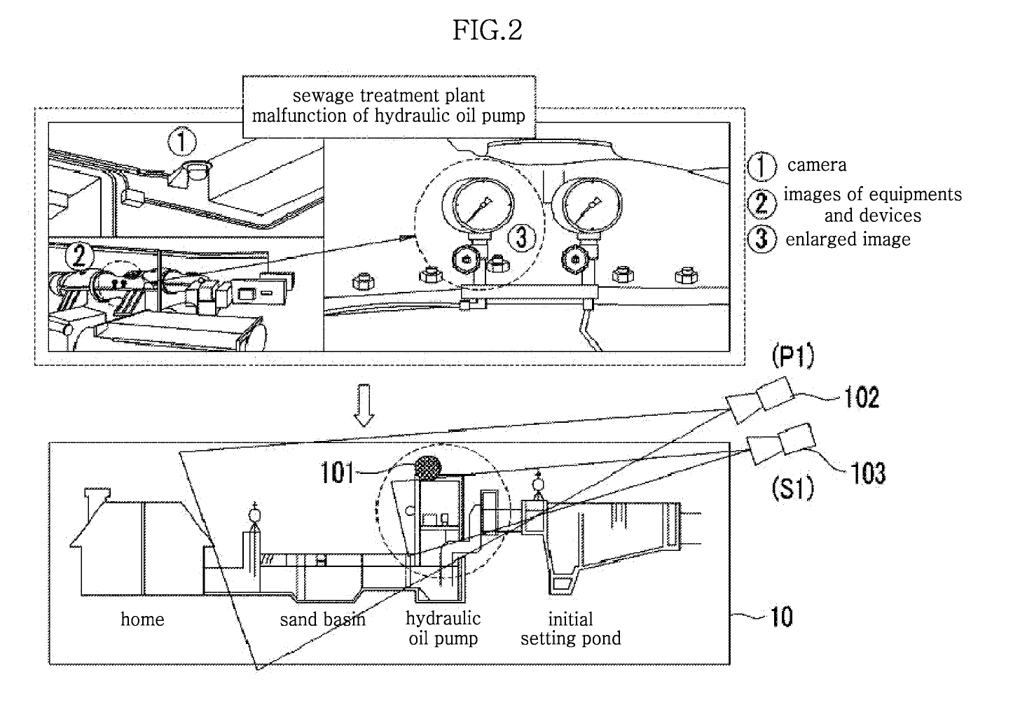

The still camera 103 is interlocked with the camera 102 for observation and driven into various angles according to the remote command provided from the situation room of the central/local monitoring center or the previously preset program so as to follow an intruder or an accident (malfunction) site when an accident (or malfunction) occurs, thereby precisely taking images. Herein, in order to keep a high response speed with respect to the remote command or the previously preset program, the camera 102 for observation and the still camera 103 may be formed into a speed dome camera in which multiple cameras are bundled up into a set or may be formed into various types depending on arrangement of the various equipments and devices of the water management facility (referring to FIGS. 1 and 2).

Further, the camera 102 for observation may have a CCTV (Closed-Circuit Television)/Web-Camera. And the camera 102 for observation and the still camera 103 may include various functions such as pan-tilt, zooming and high speed rotation according to the remote command provided from the situation room of the central/local monitoring center or the previously preset program. The reason why the camera 102 for observation and the still camera 103 have the various functions such as pan-tilt, zooming and high speed rotation is to allow the cameras to have the fast response speed and thus to rapidly focus the cameras corresponding to an installation structure and type of the various equipments and devices of the water management facility and a trespassing route of the intruder.

The camera driving part 104 functioning to drive the camera 102 for observation and the still camera 103 is driven by a controlling command of the control part 109 based on the remote command from the situation room 800 of the central/local monitoring center or the previously preset program.

The A/D converter 105 functions to convert an analog signal, such as the moving images of the camera 102 for observation, the pictures of the still camera 103, and the sound of DAQ unit or and the abnormal vibrating sound of the various equipments and the devices, which are detected by the sensor 101, into a digital signal.

The DAQ unit 106a is the PC-based data acquisition unit for collecting the abnormal sound or the abnormal vibrating sound of the various equipments and the devices of the water management facility detected by the sensor 101. The signals detected by the sensor 101 are acquired from the PC-based DAQ unit which is a signal processing device. In the PC-based DAQ unit, the signals are converted into various event data necessary for monitoring and analysis using an algorithm and then transferred to a higher-rank server through the wired and wireless communication network 200. That is, in the embodiment of the present invention, the purpose of using the PC-based DAQ unit is to measure electric or physical phenomenon such as voltage, current, pressure and sound of the various equipments (electric equipments, etc.) and devices (motor, hydraulic oil pump, etc.) of the water management facility. The PC-based data collection is performed together with a modular hardware, an application software and a computer. Each of the data collecting systems is defined depending on the requirement of the application, and also has a common goal for collecting, analyzing and displaying information. The data collecting system consists of a signal, a sensor, an actuator, a signal conditioning, a data collecting device and an application software. Since the data collecting system may use various different PC technologies, a user can flexibly select the system. For example, the user can select one of PCI, PXI, PCI Express, PCMCIA, USB, IEEE 1394, and a parallel or serial port and then perform the data collection for test, measurement and automation application.

Meanwhile, in the embodiment of the present invention, the DAQ data analysis may be analyzed through MMI (Man Machine Interface) in which various event data such as graphs, charts and reports for estimating and analyzing the cause of accident occurrences in the various equipments and device of the water management facility is previously set and stored.

In the hard disk 106b as a mass memory unit, the analog signals such as the moving images, pictures and sounds are converted into the digital signals by the A/D converter 105, synthesized by the synthesizer 107 and then stored in a compressed file. Herein, since the multiple cameras are provided so as to be corresponding to the number of the various equipments and devices of the water management facility, the hard disk 106b having a large capacity is preferably used to store the moving images and the pictures taken in real time when the movements and accidents occur and the sound and vibration collected by the DAQ unit all together.

The transceiver 108 and the speaker 108-1 can allow the central/local monitoring center to receive a report of accidents when the accidents occur in the various equipments and devices of the water management facility, can receive and store accident analyzing images recorded and analyzed from the central/local monitoring center, 3D drawings and caption data for how to deal with the accidents through an LCD monitor in real time and also can split and display them into four screens so that the local on-site worker can rapidly deal with the accidents. Further, the transceiver 108 and the speaker 108-1 can give a warning to the intruder, can inform a dangerous situation when the accidents occur and can make an announcement for dealing with the accidents.

The control part 109 is interlocked with the central/local monitoring center server 400 and controls the whole parts of the local area data collecting and recording device 100 including the sensor 101, the cameral for observation 102, the still camera 103, the camera driving part 104, the A/D converter 105, the DAQ unit 106a, the hard disk 106b, the synthesizer 107, the transceiver 108 and the speaker 108-1.

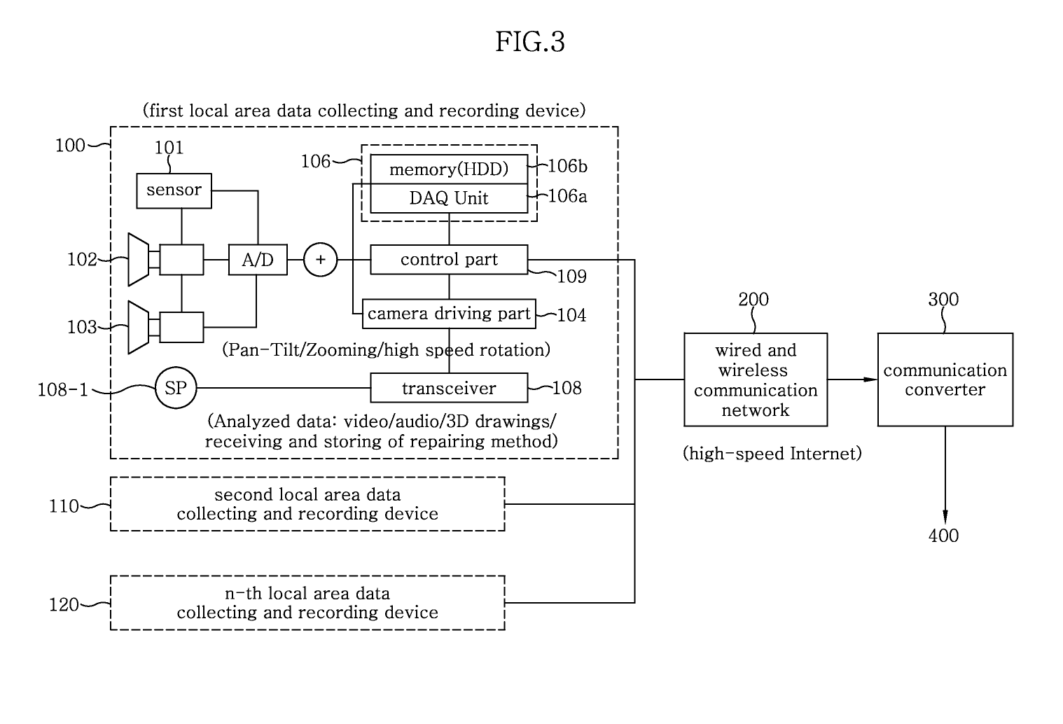

Referring to FIG. 3, the wired and wireless communication network 200 performs bidirectional data transferring between the local area data collecting and recording device 100 and the central/local monitoring center server 400. The wired and wireless communication network 200 may include a well-known high-speed Internet network, a DSRC (Dedicated Short Range Communications) method and a Zigbee module.

The communication convertor 300 functions to convert the moving image/picture/sound data of the local area data collecting and recording device 100, which have different transport protocol from each other, into a standard protocol. Herein, in the communication convertor 300, since there is a recent tendency that the industrial equipments are connected through a network with each other and information among them are monitored by a central unit, it is necessary to employ the standard protocol for easily connecting the equipments. It is possible to easily and inexpensively implement the standard protocol using an industrial communication protocol converter. The industrial communication protocol converter has an embedded standard protocol such as DNP3.0, Modbus and Lonworks, which is widely used in an electric and automation system, and thus it can be mounted in other devices, which have not the standard protocol, in order to network the devices with each other.

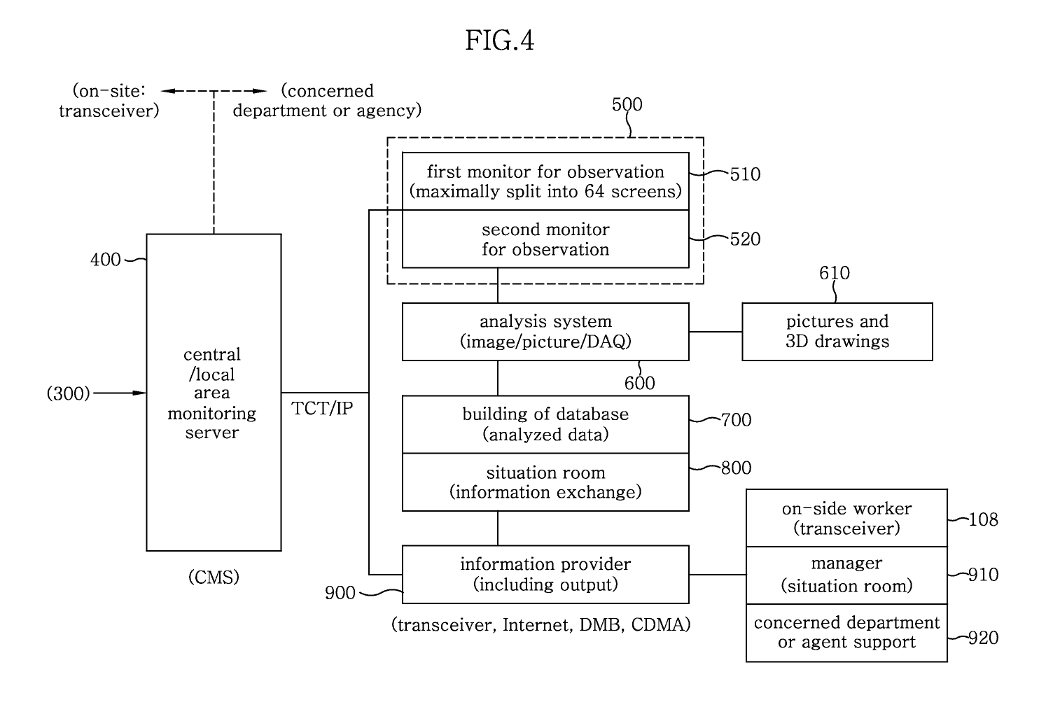

Referring to FIG. 4, the central/local monitoring center server 400 is interlocked with the wired and wireless communication network 200 and the communication converter 300. The central/local monitoring center server 400 has a CMS (Central Management System) function of converting the digital signal input to the communication converter 300 into the analog signal and providing various and convenient user support monitoring. In other words, in order to allow the bidirectional communication between the local area data collecting and recording device 100 and the central/local monitoring center server 400, the central/local monitoring center server 400 is interlocked with the wired and wireless communication network 200 and the communication converter 300 so as to be capable of storing high quality of moving images and also to allow the a network codec function to be upgraded, thereby being capable of optimally transferring the images through a multi-streaming in real time. Further, the central/local monitoring center server 400 mounts a powerful CMS program for integrally and simultaneously controlling 128 channels for providing various and convenient user support monitoring (e.g., split screen, enlargement and reduction, channel drag and drop, retrieving function, graph, chart, etc.).

Referring to FIGS. 4 to 6, the monitor 500 for observation functions to split the real-time moving images, pictures and DAQ data from the central/local monitoring center server 400 into a multi screen, and also allow the monitoring in an E-map manner.

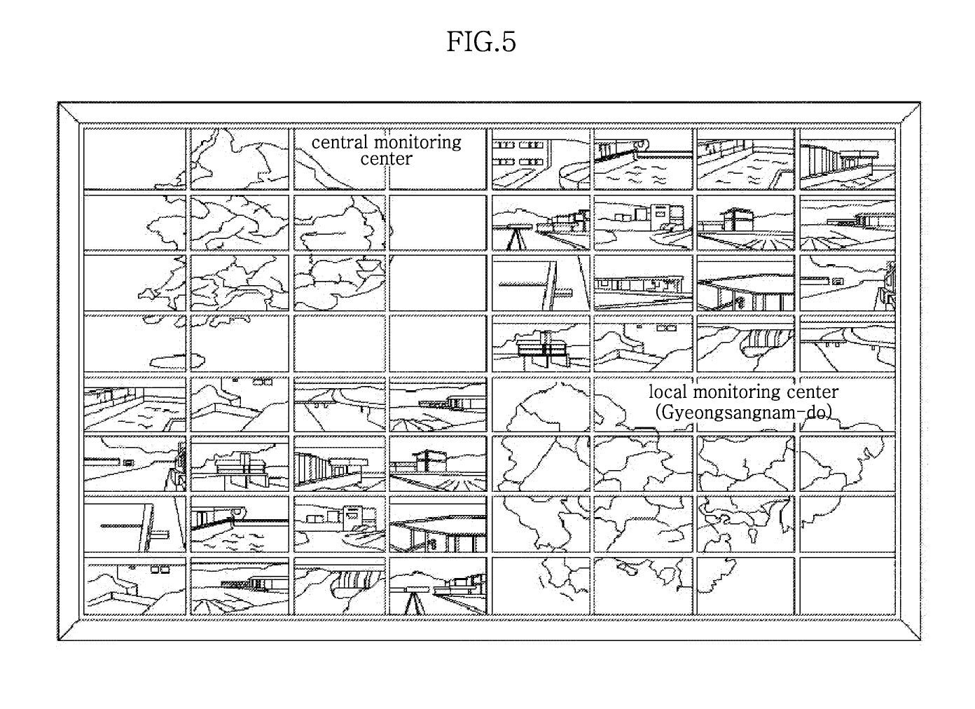

Furthermore, referring to FIG. 5, the monitor 500 for observation functions to split the real-time moving images and pictures from the central/local monitoring center server 400 into 1 to 64 screens, and includes a HD class first monitor 510 for observation and a second monitor 520 for observation, which can automatically display an icon 530 on the E-map when the intruder or accident occurs in the various equipments and devices of the water management facility.

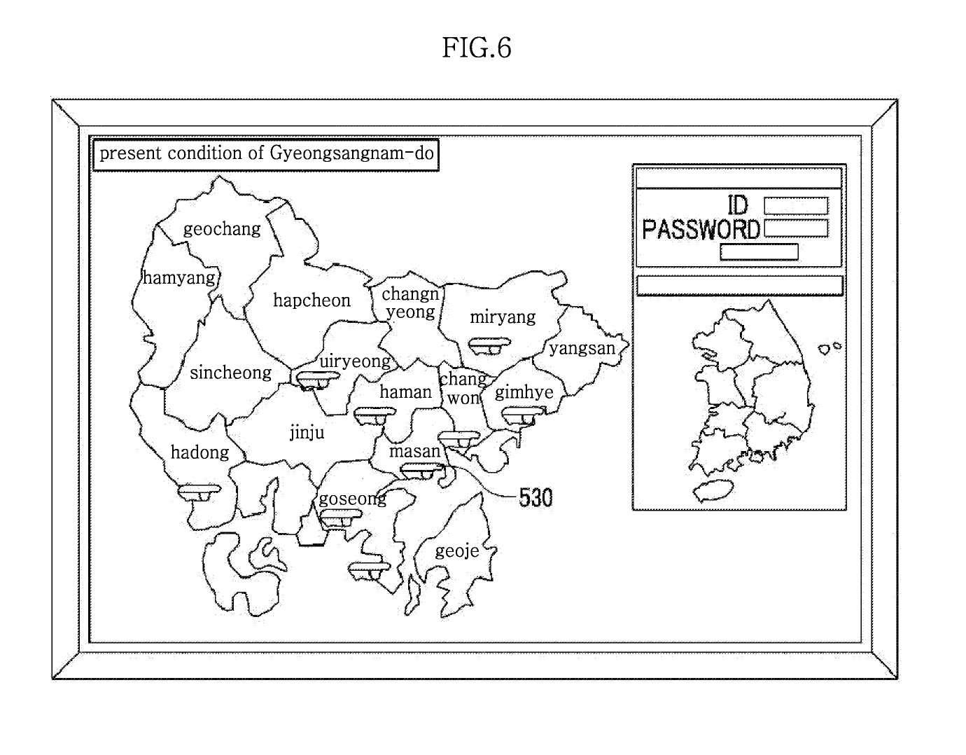

Referring to FIG. 6, in the second monitor 520 for observation, when an operator clicks the icon 530, the moving images and pictures for the accident site are split into two screens so as to display the two screens at the same time, or a text caption which is analyzed together with the pictures and 3D drawings for the accident site can be displayed on a third screen at the same time.

The text caption may include a page unit displaying function which can display date and time when the accident occurs, an accident site, a network of emergency contacts, information for how dealing with the accident all together.

Referring to FIG. 4 again, the analysis system 600 analyzes status of local area water management facilities through the first and second monitors 510 and 520 for observation. Herein, the image displayed on the second monitor 520 for observation mapped with prepared actual pictures and observing points of the 3D drawings so that the accident site can be precisely analyzed.

In other words, the moving images, the pictures and the sound data of the DAQ unit are analyzed through the first and second monitors 510 and 520 for observation. And when the pictures taken by the still camera 103 of the local area data collecting and recording device 100 is received through the wired and wireless communication network 200 in a TCP/IP of the central/local monitoring center server 400 and then displayed on the second motor 520 for observation, the resolution of the picture is considerably deteriorated and thus the image of the picture is mapped with the actual picture and the observing points of the 3D drawings, thereby precisely analyzing the accident site.

Referring to FIG. 4, the information provider 900 builds a database of the data analyzed from the analysis system 600, which can be used to make a policy for the water management in the whole country, and transfers the data to the situation room 800 of the central/local monitoring center. Therefore, the information provider 900 is to provide the information to the transceiver 108 of a local on-site worker, a manager of the local area monitoring center and a concerned department of agency 920.

In other words, the analyzed data built in the database is transferred to the central monitoring center so as to be used as a material for making a water management policy, also transferred to the corresponding area and other local area water management facilities so as to prepare for a similar case, and provided to on-site workers, managers and concerned department or agency in the corresponding area and other local area water management facilities so as to rapidly and precisely deal with the accident.

Herein, the information provider 900 provides the information through one of the transceiver 108, the well-know high-speed Internet network and the CDMA.

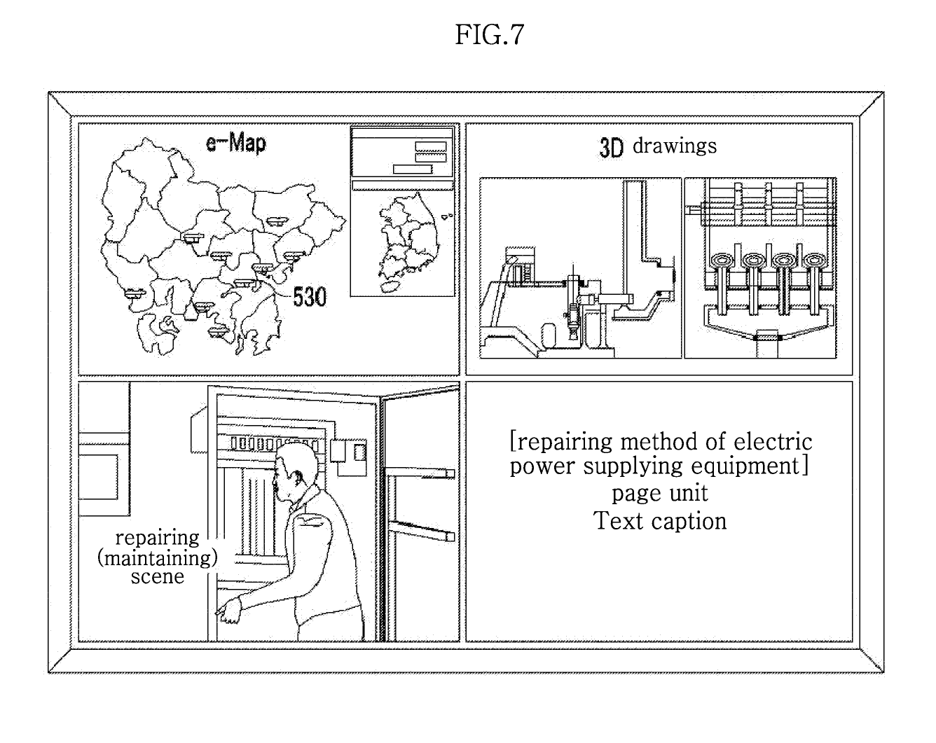

FIG. 7 shows a status of performing a repairing (maintaining) process through a transceiver of the integrated control system for facilities using the local area data collecting and recording device according to the present invention. The data analyzed in the central/local monitoring center, the 3D drawings and the repairing (maintaining) method are received and stored at the same time and then displayed on four split screens. The on-side worker can rapidly deal with the accident based on the displayed data. Further, the transceiver has an LED monitor for providing clear images and also allowing the bidirectional communication.

### INDUSTRIAL APPLICABILITY

According to the integrated control system for facilities using the local area data collecting and recording device of the present invention, if any movements or abnormal sounds are detected when comparing the reference images and the current images, the moving images are taken and also the still camera interlocked with the camera for observation precisely takes the pictures at various angles. The moving images and the pictures are transferred to the central/local monitoring center, analyzed in the situation room and then built in the database. After that, the data is provided to the on-site worker, the manger and the concerned department or agency so as to rapidly and exactly deal with the accident, thereby preventing the recurrence of the accidents and clarifying where the responsibility lies. Further, since the local area water management facilities in the whole country can be monitored at the same time, it is possible to use the information in making the water management policy and also to exchange various information.

While the present invention has been described with respect to the specific embodiments, it will be apparent to those skilled in the art that various changes and modifications may be made without departing from the spirit and scope of the invention as defined in the following claims.

What is claimed is:

1. An integrated control system for local area water management facilities such as a reservoir, a freshwater lake, a water and sewage treatment plant, a watercourse weir, a debris barrier and a multipurpose dam, comprising:
a CCTV/Web-Camera which has pan-tilt, zooming and high speed rotating functions with respect to various equipments and devices of the water management facilities, and takes moving images when detecting any movements after comparing a reference image with a current image, or detecting any abnormal sounds through a sensor;
a still camera which is interlocked with the CCTV/Web-Camera and which follows an intruder or an accident site when the intruder or accident occurs and takes pictures at various angles;
a PC-based data collection (DAQ) unit which collects various abnormal sounds detected from the sensors attached to the various equipments and devices;
a hard disk which converts and synthesizes the moving images, the pictures and sound data signals into digital signals, and then stores the digital signals in a compressed file;
a transceiver which receives and stores a caption data, and a speaker which gives warning to the intruder and informs a dangerous situation and a repairing method;
one or more local data collecting and recording devices which has a control part for controlling the above-mentioned elements and collecting video/audio data while being interlocked with a central/local monitoring center server;
a wired and wireless communication network which performs bidirectional communication between the one or more local data collecting and recording devices and a communication converter before a central/lock monitoring center;
the communication converter which converts the moving images, pictures and sound data information of the local data collecting and recording devices, which has a different transport protocol transferred from the wired and wireless communication network, into a standard protocol so as to integrally monitor the data information;
a central/local monitoring center server which is interlocked with the wired and wireless communication network and the communication converter and which has a CMS (Central Management System) function of converting digital signals input to the communication converter into analog signals and providing various and convenient user support monitoring;
a monitor for observation having a first monitor for observation, which splits real-time moving images and pictures transferred from the server into 1 to 64 screens, and a second monitor for observation, in which an icon is automatically displayed on an E-map when the intruder or the accident occurs in the water management facilities;
an analysis system which analyzes a status of the local area water management facilities through the monitor for observation, and in which the pictures displayed on the first monitor for observation is mapped with an actual image prepared before the accident and an observing point of the 3D drawings so that the accident site can be analyzed precisely; and
an information provider which builds a database of the data analyzed from the analysis system, transfers the data to a situation room of the central/local monitoring center so that the data is used in making a policy for water management in the whole country, and then also provides the data to a local on-site worker, a manager and a department or agency concerned.

2. The integrated control system according to claim 1, wherein the transceiver comprises an LCD monitor which performs the bidirectional communication, receives and stores the moving images and pictures recorded and analyzed from the central/local monitoring center, the 3D drawings, and the caption data for how to deal with the accident, and splits the data into four screens.

3. The integrated control system according to claim 1, wherein the second monitor for observation comprises a three-screen splitting function which displays the pictures for the accident site and the text caption analyzed with the 3D drawings at the same time, when an operator clicks the icon.

4. The integrated control system according to claim 3, wherein the text caption comprises a page unit displaying function which can display date and time when the accident occurs, an accident site, a network of emergency contacts, information for how dealing with the accident all together.
